(19) United States
(12) Patent Application Publication
(10) Pub. No.: US 2005/0249897 A1
(43) Pub. Date: Nov. 10, 2005

(54) Wrap for packaging at least one object, of the type consisting of a shrinkable plastic material sleeve

(75) Inventor: Eric Fresnel, Paris (FR)

Correspondence Address: MCCORMICK, PAULDING & HUBER LLP, CITY PLACE II, 185 ASYLUM STREET, HARTFORD, CT, 06103, US

(73) Assignee: Sleever International Company, Morangis (FR)

(21) Appl. No.: 10/517,958

(22) PCT Filed: Jun. 13, 2003
(86) PCT No.: PCT/FR03/01789

§ 371 Date: Dec. 14, 2004

(30) Foreign Application Priority Data
Jun. 19, 2002 (FR) 02/07549

(51) Int. Cl. F16B 4/00

(52) U.S. Cl. 428/34.9

(57) ABSTRACT

The present invention relates to a wrapper for packaging one or more articles, the wrapper being constituted by a sleeve of heat-shrink plastics material for shrinking onto the article(s) for packaging, said sleeve being obtained from a film folded in half and looped by uniting the two end zones concerned. According to the invention, the two end zones concerned are essentially touching facing free edges, and they are united by an overlap strip adhering to said zones on one of the faces of the sleeve on either side of the two facing free edges, the other face of said sleeve then being essentially smooth. This makes it possible to provide a heat-shrink sleeve that can be printed on the inside, that is recyclable, and that presents very satisfactory appearance for its smooth face on the inside or the outside.

### FIELD OF THE INVENTION

The invention relates to the field of packaging article(s), and more particularly packages made by means of a wrapper constituted by a sleeve of heat-shrink plastics material for shrinking onto the article(s) concerned.

### BACKGROUND OF THE INVENTION

The technique of packaging one or more articles using a heat-shrink sleeve made in the form of a sleeve which is placed around the article(s) for packaging and then heat-shrunk onto articles has already been in use for about thirty years. The technique of heat-shrinking by applying a heat field to the outside of the sleeve in order to shrink the sleeve uniformly on the article, even when the section of said article varies greatly, is now thoroughly mastered. Also mastered are the techniques of anamorphosis that make it possible to print on the sleeve and ensure that the printing remains readable after the sleeve has shrunk onto the article, with this being particularly important in the fields of pharmaceuticals or cosmetics.

In this type of technique, the wrapper is constituted by a sleeve of heat-shrink plastics material that is obtained from a film that is folded in half and closed by uniting the two end zones concerned. In all cases, provision is made for the two end zones concerned of the films that have been folded in half to overlap, with the two zones being placed one on the other, so that one belongs to the outside face and the other to the inside face of the sleeve as formed in this way, the zones being adhesively bonded to each other, in general by heat-sealing or by cold-setting adhesive, or sometimes by means of an adhesive that is reactivated by heat.

Such an overlap between the end zones in question leads to a certain number of drawbacks that are well known to the person skilled in the art.

The first of these drawbacks is the consequence of a sharp edge being present on the inside face of the resulting sleeve, which edge can cause scratching when the article for packaging is made of metal, for example, or is to present a face that is shiny. A second drawback lies in the difficulty of printing around the entire circumference of the inside face of the sleeve in a prior operation, it being understood that printing is performed while the film is flat, before said film is folded in half to form a sleeve. The strip corresponding to the overlapping end zones concerned spoils the printed decoration, and this spoiling of the decoration will inevitably be visible on the outside since it is necessary to use a plastics film that is transparent in order to make the sleeve.

Finally, mention should be made of a drawback that is inherent to the mechanical and chemical connection that is reinforced in the overlapping end zones, with the practically indestructible nature of this connection making it necessary to provide tear-strip systems with a line of microperforations for use when it is desired to open the heat-shrunk sleeve, e.g. in order to have access to a zone in which a flask or a bottle is closed. The person skilled in the art knows that this type of connection, in particular when heat-sealing is used, cannot be controlled very precisely, such that the coefficient of adhesion although always very high is never under control. Finally, when it is desired to use articles that are suitable for being recycled, for example bottles made of polyethylene terephthalate (PET), the reinforced connection where the end zones overlap means that the sleeve remains associated with the article that it wraps, and unfortunately the sleeve is not always made of a plastics material that is recyclable.

The state of the art relating to heat-shrunk sleeves is illustrated by the following documents U.S. Pat. No. 6,126,959, GB-A-2 280 656, WO-A-97/28062, and U.S. Pat. No. 5,775,019, and the teaching thereof is briefly outlined below.

Document U.S. Pat. No. 6,126,959 describes a heat-shrink plastics material wrapper structure with a detachable flap, made by two folds and two lines of sealing. After being shrunk onto an article, it should be observed that that structure leads to a radial edge projecting over the entire height of the wrapper, which goes against the search for a face that is smooth.

Document GB-A-2 280 656 describes a heat-shrink sleeve presenting in entirely conventional manner a tear-off strip arranged along a generator line of the sleeve.

In addition, document WO-A-97/28062 describes a wrapper having a narrow pocket. There is no question of seeking to provide a smooth face.

Document U.S. Pat. No. 5,775,019 describes a heat-shrink sleeve having two juxtaposed compartments, one of which is optionally removable and does not wrap the article, thus being free to perform some auxiliary function (a pocket for housing instructions or gloves, or a handle provided by cutouts that coincide).

Finally, mention can be made of other documents that illustrate the technological background, and that do not relate directly to heat-shrink sleeves.

For wrappers made of paper, reference can thus be made to JP-A-08 058 756 which describes a connecting bridge between two edges of a paper sleeve, the bridge being provided by a segment of heat-shrink strip (on shrinking, the paper sleeve is thus tightened by the circumferential size of the strip segment shrinking), and to JP-A-04 018 250 which describes two folded reinforced strips of paper secured to either side of an article, and having a free end that is detachable in order to form two flaps that lie face over face and constitute a handle for taking hold of the article.

For rubber wrappers, reference can be made to document U.S. Pat. No. 4,796,937 which describes a rubber sleeve closed onto a bottle and presenting a projection that acts as a handle for grasping. The facing edges are bonded together to form the wrapping cylinder.

### OBJECT OF THE INVENTION

An object of the invention is to devise a higher-performance wrapper for article-packaging article(s), that does not present the above-mentioned drawbacks inherent to the presence of a heat-sealed or adhesively-bonded overlap between end zones of a film that has been folded in half.

### GENERAL DEFINITION OF THE INVENTION

According to the invention, this problem is solved by an article-packaging wrapper, the wrapper being constituted by a sleeve of heat-shrink plastics material for shrinking onto the packaged article(s), said sleeve being obtained from a film folded in half and closed by uniting the two end zones concerned, said end zones having facing free edges that are essentially touching, and being united by an overlap strip adhering to said zones on one face of the sleeve on either side of the two facing free edges, the other face of said sleeve then being essentially smooth.

In a particular embodiment, the overlap strip adheres to the end zones on the outside face of the sleeve, the inside face of said sleeve being essentially smooth. In particular, the essentially smooth inside face of the sleeve is decorated, the decoration being visible from the outside by transparency.

The presence of an essentially smooth inside face avoids any risk of articles being scratched in the event of the walls of an article being fragile or shiny.

In a variant, provision can be made for the overlap strip to adhere to the end zones on the inside face of the sleeve, the outside face of said sleeve being essentially smooth.

By way of example, a sleeve having a smooth outside face may be particularly welcome in the field of perfumery, so as to ensure that the outside wrapper presents good feel when held.

The overlap zone may be bonded to the end zones by means such as heat-sealing, ultrasound welding, or in a variant adhesive or the like, in which case the coefficients of adhesion may be identical or different on either side of the two facing free edges. When using an adhesive or the like, provision can be made for the substance such as an adhesive or a varnish that is used for bonding purposes to be soluble in an appropriate solvent, so as to make the packaged article(s) more suitable for recycling. When the wrapped article is discarded after use, it then suffices to soak it in a batch of said solvent to cause the sleeve to open naturally and become detached from the packaged article. The substance such as adhesive or varnish could, in a variant, be a peel-off adhesive, so as to make it easier to remove the overlap strip and open the sleeve.

In another embodiment, the overlap strip is extended laterally, at least one side thereof, by a flap that does not adhere to the outside face of the sleeve, or at most adheres via isolated spots only. In particular, the or each flap is connected to the portion of the overlap strip which adheres to the outside face of the sleeve via a precut line, so that said flap is detachable.

In a variant, provision can be made for the or each flap to present an internal cutout so that said flap can act as a handle for holding the packaged article(s).

In another particular embodiment, the overlap strip presents at least one line of microperforations extending in the longitudinal direction of said strip, in the vicinity of the facing free edges, so as to enable the sleeve to be torn open.

Provision can also be made, in the vicinity of at least one bonding zone of the overlap strip, for the wall of the sleeve to present a line of microperforations so as to enable the sleeve to be torn open.

Under such circumstances, the overlap strip is advantageously extended at one of its ends by an opening tab.

Finally, provision can be made for the overlap strip to be made of mono- or bi-oriented heat-shrink plastics material having strong shrinking power in its width direction, so that it is itself shrunk onto the article(s) together with the wall of the sleeve.

### BRIEF DESCRIPTION OF THE DRAWINGS

Other characteristics and advantages of the invention will appear more clearly in the light of the following description and the accompanying drawings showing particular embodiments.

Reference is made to the figures, in which:

FIG. 1 shows a packaging wrapper in accordance with the invention being put into place on an article, which in this case is a perfume spray, the sleeve constituting the wrapper presenting an overlap strip bonded to the outside face of the sleeve;

FIG. 2 is a section on II-II of FIG. 1 through the sleeve on its own;

FIG. 3 shows the article on which the above-mentioned sleeve has been heat-shrunk;

FIG. 4 is a fragmentary section showing the zone of the overlap strip forming part of the sleeve shrunk onto the article;

FIGS. 5 to 7 are similar to above FIGS. 1, 2, and 4, and show a variant in which the overlap strip is bonded to the inside face of the sleeve;

FIG. 8 is a perspective view showing a sleeve whose essentially smooth inside face is decorated;

FIG. 9 and FIG. 10, which is a section thereof on X-X, show a variant in which the overlap strip is extended laterally by a detachable flap;

FIG. 11 and FIG. 12, which is a section thereof on XII-XII, show another variant in which the overlap strip is extended by two detachable lateral flaps;

FIGS. 13 and 14 show two other variants in which the overlap strip is extended laterally respectively by one or by two flaps for forming a handle; and

FIGS. 15 and 16 show two other variants in which the overlap strip is extended respectively by a flap or by an opening tab serving as a pull member for opening the sleeve when in the shrunk state on the article(s) concerned.

### DETAILED DESCRIPTION OF PREFERRED EMBODIMENTS

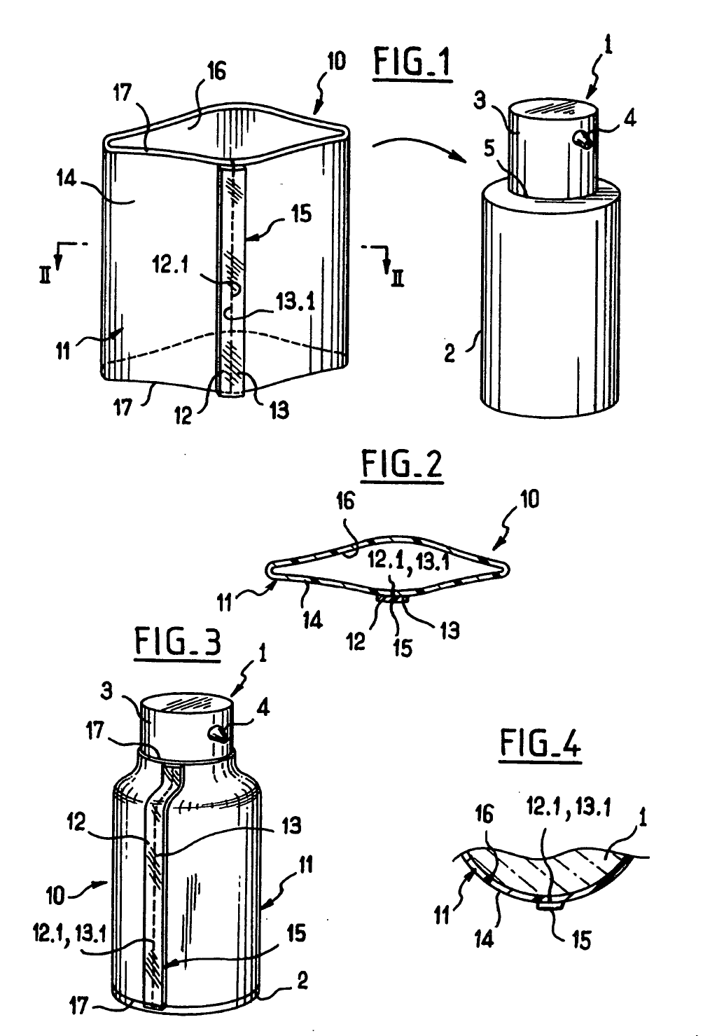

FIGS. 1 and 2 show a wrapper in accordance with the invention for packaging article(s), the wrapper serving in this case to wrap a single article referenced 1, which article is constituted by a perfume spray, comprising a body 2 surmounted by a pushbutton-forming cap 3 fitted with a spray nozzle 4, the circular connection zone, referenced 5, corresponding to a large change in section between the body 2 and the cap 3.

The packaging wrapper referenced 10 is constituted by a sleeve 11 of heat-shrink plastics material, which sleeve is open at both ends, being defined by two free edges 17 that occupy two parallel transverse planes. The sleeve 11 is shown here as not being perfectly cylindrical, but as being in the form of an open sheath having two end folds, as a reminder that this type of sleeve is obtained by cutting segments from a flat sheath that is wound on a reel.

The sleeve 11 is thus obtained from a film that is folded in half and closed by uniting the two end zones concerned. In accordance with an essential characteristic of the invention, the two end zones concerned, referenced 12 and 13, are facing free edges 12.1 and 13.1 which are essentially touching, with these zones being united by an overlap strip 15 that is bonded to both zones over one of the faces of the sleeve 11 on either side of the two facing free edges 12.1 and 13.1, while the other face of said sleeve then remains essentially smooth.

Thus, unlike the techniques that are in universal use for making heat-shrink sleeves obtained from a film that is folded in half and closed by uniting mutually overlapping end zones, in this case, the end zones are placed edge to edge so that the face of the sleeve opposite from the face carrying the overlap strip 15 is perfectly smooth.

In the variant of FIG. 1, the overlap strip 15 adheres to the end zones 12, 13 on the outside face 14 of the sleeve, so that the inside face 16 of said sleeve is essentially smooth.

Once the sleeve 11 has been placed over the article 1, said sleeve is heat-shrunk onto said article in conventional manner, thus leading to the configuration shown in FIG. 3. The article 1 is then surrounded both around its body 2 and around its cap 3 by the heat-shrunk sleeve.

The overlap strip 15 may be made of amorphous plastics material, in which case said strip is not involved in shrinking, which does not matter insofar as far as the width of this overlap strip is small in practice. Nevertheless, it may be preferred for the overlap strip 15 to be made of a mono- or bi-oriented heat-shrink plastics material having high shrinkage power in its width direction, so that it is itself shrunk onto the article together with the wall of the sleeve 11, thereby “tracking” the deformation of said wall during shrinkage.

The section of FIG. 4 shows clearly the two ends of the film constituting the sleeve 11 which are brought free edge against free edge (edges 12.1 and 13.1). This edge-to-edge disposition eliminates the sharp edge which is inevitably present in the conventional configuration of one of the end zones of the closed film being overlapped on the other. This avoids any risk of scratching the article when the wall of said article is fragile.

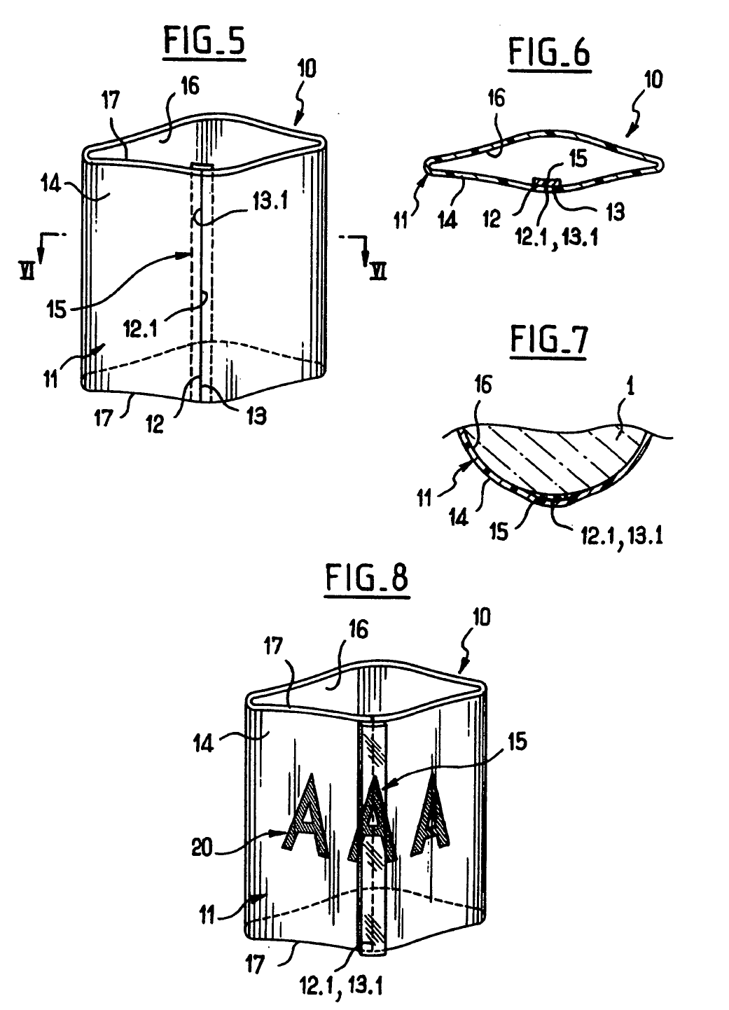

As shown in FIGS. 5 to 7, in a variant, provision can be made for the overlap strip 15 to be bonded to the end zones 12, 13 on the inside face 16 of the sleeve 11, in which case it is the outside face 14 of said sleeve that is then essentially smooth. Such an embodiment is more particularly desirable when it is desired for the article that is packaged by a heat-shrink sleeve made in this way to have an outside appearance that is completely clean, as can be the case in the field of perfumery.

Another advantage of the smooth inside wall of the sleeve lies in the possibility of organizing printing with sophisticated decoration over the entire inside face of the sleeve, with the printing being performed while the film is still flat, prior to the film being folded in half to form the sleeve. FIG. 8 shows this advantage, and it can be seen that the essentially smooth inside face 16 of the sleeve 11 is decorated in this case by means of a pattern referenced 20, which pattern can be seen from the outside because the film is transparent. Specifically, the pattern 20 is represented by three letters “A”, one of which is disposed astride the facing free edges 12.1 and 13.1. Because there is no overlap between the end zones 12 and 13, and because the ends of the film are placed free edge against free edge, the printing that is performed while the film is flat, is not affected in any way by the film being folded in half in order to constitute the sleeve. The full 360° of the cylindrical surface is thus made entirely available for printing and/or decorating the sleeve. For this purpose, use can be made of printing techniques that use a sublimable ink, with the force generated by the sleeve shrinking contributing to transferring the decoration made using sublimable ink onto the packaged article.

In general, whatever the position of the overlap strip 15, provision can be made for said overlap strip to be bonded to the end zones 12 and 13 by heat-sealing or by ultrasonic welding, or in a variant for it to be bonded to the end zones 12 and 13 by adhesive or the like.

When using adhesive, it is possible for the coefficient of adhesion on either side of the facing free edges 12.1 and 13.1 to be identical or different, depending on circumstances. The strip 15, which may be an adhesive strip, may receive coatings of adhesive or varnish that are selected for the respective halves of its width on opposite sides of the zone of contact between the edges of the sleeve wall. It is then possible to have complete control over the coefficient of adhesion, depending on the application concerned, and consequently it is possible to determine accurately the tearing force that will be required to open the sleeve, with such a force being specific to each application under consideration.

In addition, when using an adhesive or the like for the overlap strip, provision can be made for the adhesive or the varnish used to be soluble in an appropriate solvent, e.g. hot water, so as to make the packaged article(s) more suitable for recycling. When the packaged article is discarded, it suffices for the empty package to be recovered and plunged into a bath of the solvent in order to cause the film covering the article to become unstuck, with the sleeve then opening quite naturally in the vicinity of the overlap strip. It then suffices to recover the opened sleeve which has returned to the state of a flat film, in order to be able to recover the packaged containers, e.g. bottles of polyethylene terephthalate. Naturally, under such circumstances, provision can be made to enhance the recyclable nature of the packaging as a whole by making the sleeve from a plastics material that is likewise suitable for being recycled, e.g. oriented polypropylene (OPP).

Provision can also be made for the substance such as adhesive or varnish that is used for sticking the overlap strip 15 to be a peel-off adhesive, so as to make it easier to remove said strip in order to open the sleeve 11.

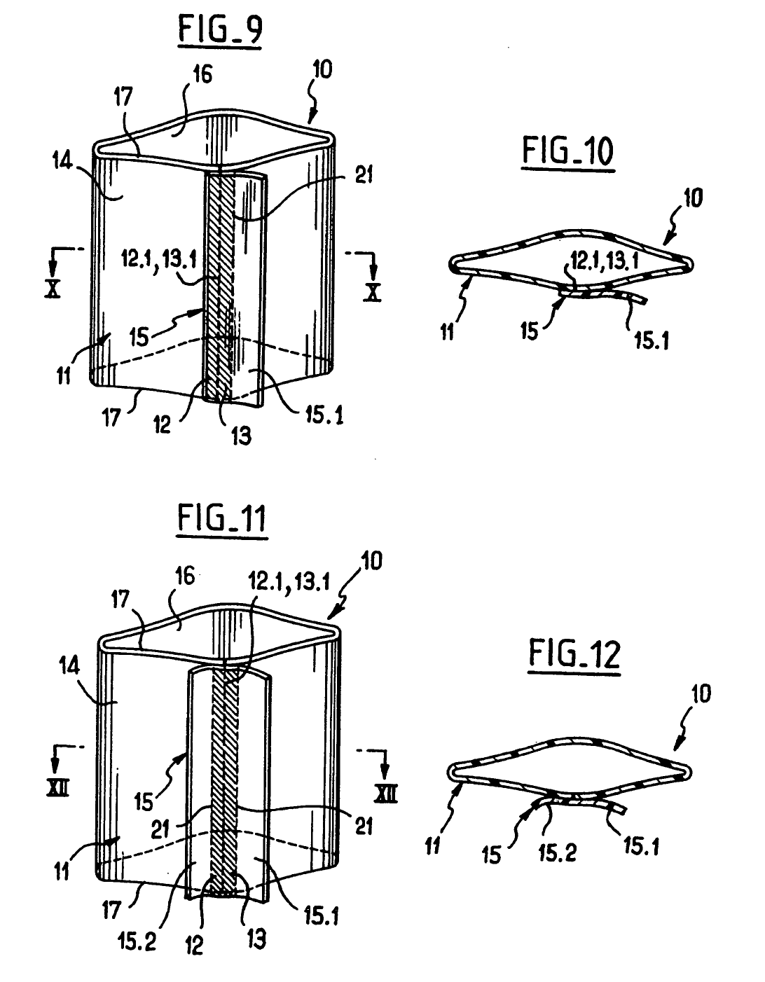

In accordance with another variant of the invention, it is possible to make provision for the overlap strip 15 to be extended, on at least one side thereof, by a flap that does not adhere to the outside face 14 of the sleeve 11, or at least adheres thereto via isolated spots only. Such variants are shown in FIGS. 9 to 15.

In FIGS. 9 and 10, it can be seen that the overlap strip 15 is extended laterally on one side thereof by a flap 15.1 that does not adhere to the outside face 14 of the sleeve 11. FIG. 9 has a shaded area representing the portion of the overlap strip 15 that is bonded to the outside wall 14 of the sleeve 11. Such a flap can be used for carrying information, or in a variant it can constitute a removable coupon, in which case the flap 15.1 is connected to the portion of the overlap strip 15 which is bonded to the outside face 14 of the sleeve 11 via a precut line such as the line 21.

FIGS. 11 and 12 show a variant in which the overlap strip 15 is extended laterally on both sides by flaps 15.1 and 15.2, each of these flaps being detachable via an associated precut line 21.

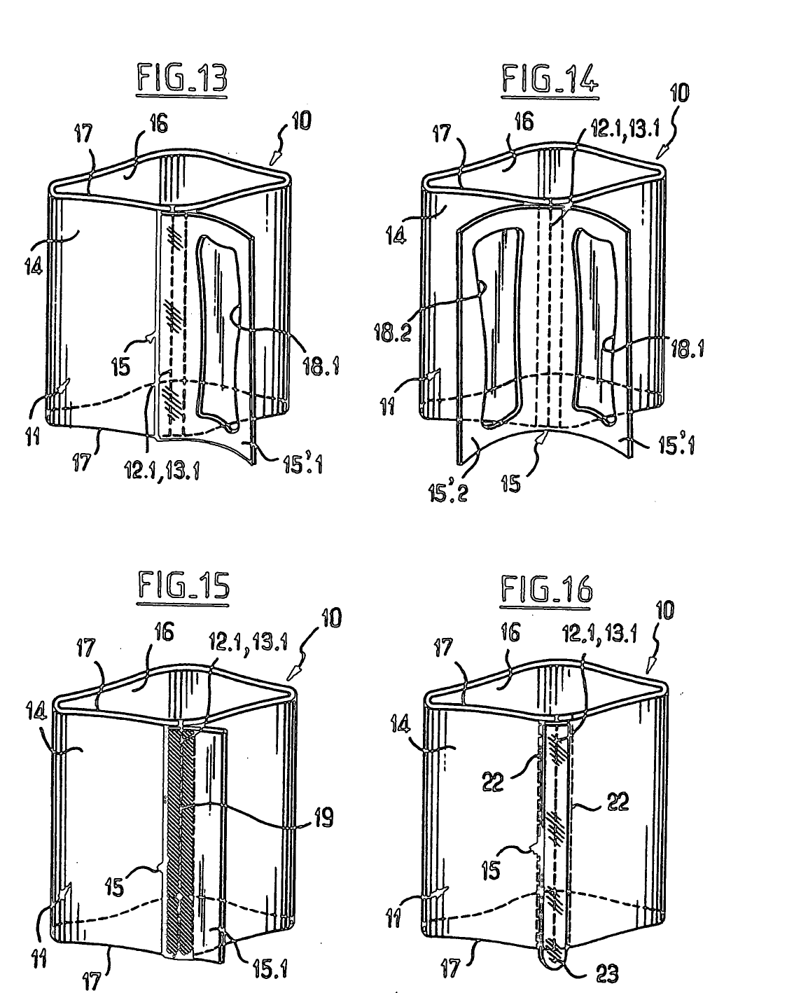

Another function can be performed by such a flap that does not adhere to the outside face 14 of the sleeve 11, in particular a function of holding the article. This is shown in FIGS. 13 and 14, where it can be seen that the single flap 15′.1 (FIG. 13) or the two flaps 15′.1, 15′.2 (FIG. 14) present internal cutouts 18.1, 18.2, such that each flap concerned can be used as a handle for holding the packaged article(s). The presence of an internal cutout in these flaps, where cutting out can be performed while the film is still flat, runs the risk of possibly leading to unattractive deformation while the sleeve is being shrunk, however this is of little importance since the flaps are narrow. For flaps that are wide, reinforcing elements could be provided surrounding the peripheral outlines of the cutout (variant not shown herein).

FIG. 15 shows another function performed by a flap 15.1 laterally extending the overlap strip 15. This is a function of enabling the sleeve that has been heat-shrunk onto the article in question to be torn off. In this case, provision is made for the overlap strip 15 to present at least one line of microperforations 19 extending in the longitudinal direction of said strip in the vicinity of the facing free edges 12.1 and 12.2 so as to enable the sleeve 11 to be opened by being torn open. The flap 15.1 then makes it easier to grasp the sleeve in order to exert the necessary tearing force thereto.

In FIG. 16, there can be seen another variant, in which the overlap strip 15 performs the function of a tear-off strip in addition to its uniting function for closing the film in a loop. Under such circumstances, in the vicinity of at least one bonding zone of the overlap strip 15, and in this case both zones, the wall of the sleeve 11 presents a line of microperforations 22 so as to enable the sleeve 11 to be torn open by pulling on the overlap strip. In order to facilitate applying the force needed for tearing open, provision can be made, as also shown in FIG. 16, for the overlap strip 15 to be extended at one end by a pull tab 23.

A packaging wrapper is thus provided which is constituted by a heat-shrink sleeve presenting an inside face or an outside face that is essentially smooth, because the facing free edges of the film are essentially touching. The term “essentially touching” as used in the context of the present description covers an edge-to-edge gap lying in the range 0 to ten-tenths of a millimeter only. When the gap becomes too great, the drawback of the traditional overlap reappears with sharp edges.

Although the wrappers described above relate to packaging single articles, the invention can also be applied to sleeves having a plurality of compartments enabling a plurality of articles to be wrapped.

The invention is not limited to the embodiments described above, but on the contrary covers any variant using equivalent means to reproduce the essential characteristics specified above.

1. A wrapper for packaging one or more articles, the wrapper being constituted by a sleeve of heat-shrink plastics material for shrinking onto the article(s) for packaging, said sleeve being obtained from a film folded in half and looped by uniting the two end zones concerned, wherein the two end zones concerned are essentially touching facing free edges, and they are united by an overlap strip adhering to said zones on one of the faces of the sleeve on either side of the two facing free edges, the other face of said sleeve then being essentially smooth.

2. An article-packaging wrapper according to claim 1, wherein the overlap strip adheres to the end zones on the outside face of the sleeve, the inside face of said sleeve being essentially smooth.

3. An article-packaging wrapper according to claim 2, wherein the essentially smooth inside face of the sleeve is decorated, the decoration being visible from the outside by transparency.

4. An article-packaging wrapper according to claim 1, wherein the overlap strip adheres to the end zones on the inside face of the sleeve, the outside face of said sleeve being essentially smooth.

5. An article-packaging wrapper according to claim 1, wherein the overlap strip is bonded to the end zones by means such as heat-sealing, ultrasound welding, or adhesive.

6. An article-packaging wrapper according to claim 1, wherein the overlap strip adheres to the end zones by adhesive or the like, with the coefficient of adhesion on either side of the two facing free edges being identical or different.

7. An article-packaging wrapper according to claim 6, wherein the substance such as adhesive or varnish used for bonding the overlap strip is soluble in a suitable solvent, so as to make the packaged article(s) more suitable for recycling.

8. An article-packaging wrapper according to claim 6, wherein the substance such as adhesive or varnish used for bonding the overlap strip is a peel-off adhesive, so as to facilitate removal of said strip and opening of the sleeve.

9. An article-packaging wrapper according to claim 1, wherein the overlap strip is extended laterally, at least on one side thereof, by a flap that does not adhere to the outside face of the sleeve, or that adheres thereto via isolated points only.

10. An article-packaging wrapper according to claim 9, wherein the or each flap is connected to the portion of the overlap strip which adheres to the outside face of the sleeve via a precut line so that said flap is detachable.

11. An article-packaging wrapper according to claim 9, wherein the or each flap presents an internal cutout, so that said flap can be used as a handle for grasping the packaged article(s).

12. An article-packaging wrapper according to claim 1, wherein the overlap strip presents at least one line of microperforations extending in the longitudinal direction of said strip, in the vicinity of the facing free edges so as to enable the sleeve to be torn open.

13. An article-packaging wrapper according to claim 1, wherein the wall of the sleeve presents a line of microperforations in the vicinity of at least one of the zones where the overlap strip adheres thereto, thereby enabling the sleeve to be torn open.

14. An article-packaging wrapper according to claim 12, wherein the overlap strip is extended at one end by a pull tab.

15. An article-packaging wrapper according to claim 1, wherein the overlap strip is made of a mono- or bi-oriented heat-shrink plastics material having high shrinkage power in the width direction thereof, so that it is itself shrunk onto the article(s) together with the wall of the sleeve.
